(19) United States
(12) Patent Application Publication
(10) Pub. No.: US 2007/0143016 A1
(43) Pub. Date: Jun. 21, 2007

(54) PORTABLE DEVICE AND METHOD FOR PROVIDING NAVIGATION DATA

(76) Inventors: Shao-Tsu Kung, Taipei City (TW); Ko-Chien Chuang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,307

(22) Filed: Mar. 16, 2006

(30) Foreign Application Priority Data
Dec. 19, 2005 (TW) 94145030

(51) Int. Cl. G01C 21/00

(52) U.S. Cl. 701/213

(57) ABSTRACT

A portable device capable for providing navigation data and the method thereof. The portable device includes a mask ROM (Read Only Memory), an input unit, a RAM (Random Access Memory), a GPS (Global Positioning System) unit, a CPU (Central Processing Unit), and an output unit. First, an updated navigation map data is provided into the input unit of the portable device and stored in the RAM. Then, the CPU compares the updated navigation map data with an original navigation map data stored in the mask ROM to generate a revised navigation map data. Afterwards, the CPU calculates the position of the user on the revised navigation map data according to a positioning coordinate from the GPS unit.

### CROSS-REFERENCE TO RELATED APPLICATION

This application claims the priority benefit of Taiwan application serial no. 94145030, filed on Dec. 19, 2005. All disclosure of the Taiwan application is incorporated herein by reference.

### BACKGROUND OF THE INVENTION

1. Field of the Invention

The present invention relates to a portable device and a method for providing navigation data, and more particularly, to a portable device and a method for providing navigation data by using a mask ROM.

2. Description of the Related Art

FIG. 1 schematically shows a hot pluggable GPS electronic peripheral adapter for providing navigation data, which is disclosed in R.O.C. Patent No. 535959 of “Hot Pluggable Electronic Peripheral Adapter of GPS Providing Navigation Data”. Referring to FIG. 1, the GPS electronic peripheral adapter 1 comprises a hot pluggable adapter interface 2, a GPS module 3, a host interface 4, a serial-to-parallel converter 5, and a multi-interface controller 6.

The hot pluggable adapter interface 2 is electrically coupled to the multi-interface controller 6 for hot plugging a memory card 21 where the map data is stored. The GPS module 3 receives a positioning signal from a GPS and calculates the related positioning coordinate. The host interface 4 is electrically coupled to the multi-interface controller 6 for plugging in a host device (not shown). When the memory card 21 is plugged into the hot pluggable adapter interface 2, an interrupt signal IRQA is issued by the hot pluggable adapter interface 2 to notify the multi-interface controller 6. Then, the multi-interface controller 6 issues an interrupt signal IRQC to notify the host device through the host interface 4 to read the map data stored in the memory card 21 and to display the map where the user is currently located. In addition, after the positioning coordinate is calculated by the GPS module 3, an interrupt signal IRQB is issued to notify the multi-interface controller 6. Then, the multi-interface controller 6 issues the interrupt signal IRQC to notify the host device through the host interface 4 to read the positioning coordinate calculated by the GPS module 3, compares it with the original loaded map data, and marks the coordinate position on the map.

In addition, the host interface 4 may be a PCMCIA/CF interface, and the card detecting pins CD#1 and CD#2 of the host interface 4 are fixed on the voltage level that indicates the card is inserted. Moreover, the card detecting pins CD#1 and CD#2 are permanently grounded. The electronic peripheral adapter 1 has the address/data/control signals that are transmitted between the hot pluggable adapter interface 2 and the multi-interface controller 6, between the GPS module 3 and the serial-to-parallel converter 5, between the serial-to-parallel converter 5 and the multi-interface controller 6, and between the multi-interface controller 6 and the host interface 4.

It is known from the description mentioned above, the conventional GPS electronic peripheral adapter requires the user to insert the memory card to provide the map data, which is very inconvenient to the user. If the user forgets to carry the memory card or the memory card is lost, the GPS fails to function.

### SUMMARY OF THE INVENTION

Therefore, it is an object of the present invention to provide a portable device capable for providing navigation data. Comparing with the conventional technique, the present invention provides a portable device with lower cost and higher reading speed.

It is another object of the present invention to provide a method for providing navigation data. The method uses the memory card or other similar device to input the updated navigation map data. Accordingly, even when the user forgets to carry the memory card, the updated navigation map data can be provided through a wireless communication manner that effectively receives and processes the navigation map data and the positioning coordinate.

The portable device of the present invention comprises a mask ROM, an input unit, a GPS unit, a RAM, and a CPU. Wherein, the mask ROM stores and provides an original navigation map data. The input unit receives an updated navigation map data that is then stored in the RAM. The GPS unit receives the positioning coordinate transmitted by a GPS. In addition, the CPU is electrically coupled to the mask ROM, the input unit, the RAM, and the GPS unit. Wherein, the CPU reads the original navigation map data. When the updated navigation map data exists, the original navigation map data is revised by the updated navigation map data, such that a revised navigation map data is generated. Moreover, a position represented by the positioning coordinate on the revised navigation map data is founded.

In an embodiment of the present invention, the input unit of the portable device capable for providing navigation data is one of a wired data transmission module, a wireless data transmission module, and a GPRS network data transmission module.

In an embodiment of the present invention, the portable device capable for providing navigation data further comprises an output unit. The output unit is electrically coupled to the CPU for displaying the revised navigation map data and the position represented by the positioning coordinate.

In the method for providing navigation data of the present invention, first the original navigation map data is stored in the mask ROM. Then, it is determined whether an updated navigation map data exists or not. If the updated navigation map data exists, the revised navigation map data is generated by referring to the updated navigation map data and the original navigation map data. Then, a positioning coordinate is received. Finally, the location of the positioning coordinate on the updated navigation map data is founded.

In an embodiment of the present invention, the method for providing navigation data further comprises the following steps. First, the updated navigation map data is received through one of the wired data transmission module, the wireless data transmission module, and the GPRS network data transmission module. Then, the updated navigation map data is stored in the RAM.

In an embodiment of the present invention, the method capable for providing navigation data further comprises a step of using the display unit to display the revised navigation map data and the location of the positioning coordinate.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 schematically shows a hot pluggable GPS electronic peripheral adapter for providing navigation data.

FIG. 2 schematically shows a circuit diagram of a portable device capable for providing navigation data according to an embodiment of the present invention.

FIG. 3 schematically shows a flow chart illustrating a method for providing navigation data according to an embodiment of the present invention.

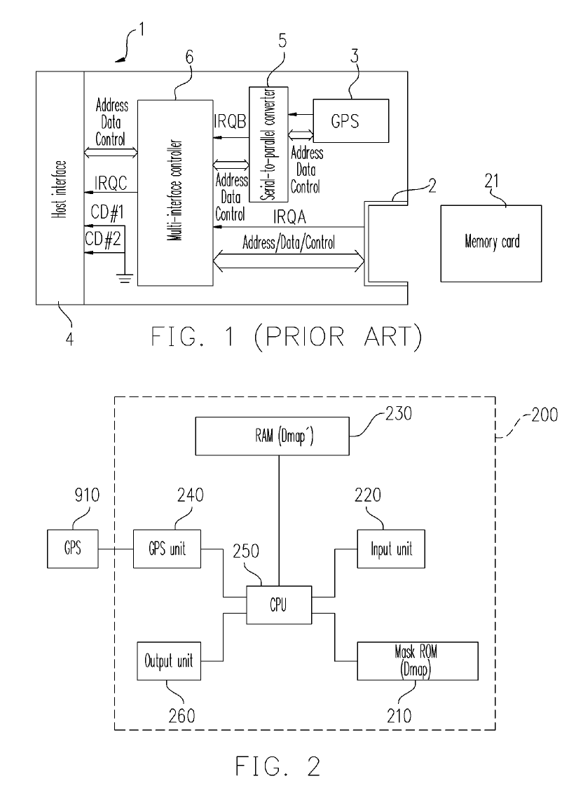

### DESCRIPTION PREFERRED EMBODIMENTS

FIG. 2 schematically shows a circuit diagram of a portable device capable for providing navigation data according to an embodiment of the present invention. Referring to FIG. 2, the portable device can be applied in the electronic devices having the computing function and the display unit such as the portable computer, the Personal Digital Assistance (PDA), and the cellular phone.

The portable device 200 comprises a mask ROM 210, an input unit 220, a RAM 230, a GPS unit 240, and a CPU 250. Wherein, the mask ROM 210 stores and provides an original navigation map data Dₘₐₚ, and the input unit 220 receives an updated navigation map data Dₘₐₚ′. The RAM 230 stores the updated navigation map data Dₘₐₚ′, and the GPS unit 240 receives a positioning coordinate from a GPS 910. The CPU 250 is electrically coupled to the mask ROM 210, the input unit 220, the RAM 230, and the GPS unit 240. Wherein, the CPU 250 reads the original navigation map data Dₘₐₚ, and uses the updated navigation map data Dₘₐₚ′ to revise the original navigation map data Dₘₐₚ when the updated navigation map data Dₘₐₚ′ exists, such that a revised navigation map data is generated and the position represented by the positioning coordinate is founded on the revised navigation map data.

The input unit 220 mentioned above may be one of a wired data transmission module, a wireless data transmission module, and a GPRS network data transmission module. In the wireless data transmission module, one of the following protocols can be used: the Bluetooth protocol, the wireless local area network (IEEE 802.11) protocol, the DECT (Digital Enhanced Cordless Telecommunications) protocol, and the IRDA (Infra red direct access) protocol. The portable device 200 mentioned above further comprises an output unit 260 such as an LCD display unit that is electrically coupled to the CPU 250 for displaying the revised navigation map data and the position represented by the positioning coordinate.

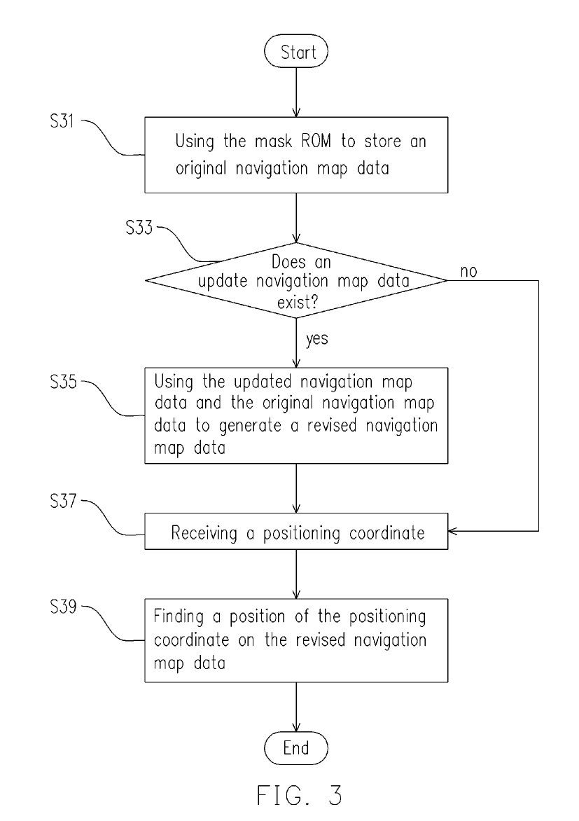

FIG. 3 schematically shows a flow chart illustrating a method for providing navigation data according to an embodiment of the present invention. Referring to FIGS. 2 and 3, first in step S31, an original navigation map data Dₘₐₚ is stored in the mask ROM. Then, in step S33, the input unit 220 uses at least one of the wired data transmission module, the wireless data transmission module, and the GPRS network data transmission module to receive an updated navigation map data Dₘₐₚ′. Then, the input unit 220 stores the updated navigation map data Dₘₐₚ′ into the RAM 230, and determines whether the updated navigation map data Dₘₐₚ′ exists or not. Then, in step S35, if the updated navigation map data Dₘₐₚ′ exists, the updated navigation map data Dₘₐₚ′ and the original navigation map data Dₘₐₚ are used to generate a revised navigation map data. In step S37, a positioning coordinate is received. Finally, in step S39, a position represented by the positioning coordinate on the revised navigation map data is founded, and the display unit 260 displays the revised navigation map data and the position of the positioning coordinate.

In summary, in the portable device capable for providing navigation data of the present invention, the input unit 220 receives the updated navigation map data Dₘₐₚ′, and stores it in the RAM 230. Then, the updated navigation map data Dₘₐₚ′ is compared with the original navigation map data Dₘₐₚ originally stored in the mask ROM 210 to generate a revised navigation map data. The GPS unit 240 receives a positioning coordinate from the GPS 910. Then, the position represented by the positioning coordinate is marked on the revised navigation map data, and the output unit 260 of the portable device 200 displays the revised navigation map data and the position represented by the positioning coordinate. Accordingly, the portable device 200 of the present invention eliminates the inconvenience of carrying the memory card and reduces the cost. Moreover, the present invention compares the updated navigation map data Dₘₐₚ′ with the original navigation map data Dₘₐₚ originally stored in the mask ROM 210 to obtain the revised navigation map data, such that the purpose of reducing the computation is achieved. Accordingly, the portable device of the present invention provides a user with convenience, portability and reasonable price.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A portable device capable for providing navigation data, comprising:
a mask ROM for storing and providing an original navigation map data;
an input unit for receiving an updated navigation map data;
a RAM for storing the updated navigation map data;
a GPS unit for receiving a positioning coordinate from a GPS; and
a CPU electrically coupled to the mask ROM, the input unit, the RAM, and the GPS unit, wherein the CPU reads the original navigation map data, and when the updated navigation map data exists, the CPU uses the updated navigation map data to revise the original navigation map data in order to generate a revised navigation map data and to find a position represented by the positioning coordinate on the revised navigation map data.

2. The portable device capable for providing navigation data of claim 1, further comprising an output unit electrically coupled to the CPU for displaying the revised navigation map data and the position represented by the positioning coordinate.

3. The portable device capable for providing navigation data of claim 1, wherein the input unit is a wired data transmission module.

4. The portable device capable for providing navigation data of claim 1, wherein the input unit is a wireless data transmission module.

5. The portable device capable for providing navigation data of claim 4, wherein the input unit comprises a GPRS network data transmission module.

6. A method for providing navigation data suitable for a portable device, comprising:
using a mask ROM to store an original navigation map data;
determining whether an updated navigation map data exists or not;
if the updated navigation map data exists, using the updated navigation map data and the original navigation map data to generate a revised navigation map data;
receiving a positioning coordinate; and
finding a position of the positioning coordinate on the revised navigation map data.

7. The method for providing navigation data of claim 6, further comprising using a wired data communication module to receive the updated navigation map data.

8. The method for providing navigation data of claim 6, further comprising using a GPRS network data communication module to receive the updated navigation map data.

9. The method for providing navigation data of claim 8, further comprising using a RAM to store the updated navigation map data.

10. The method for providing navigation data of claim 6, further comprising using a display unit to display the revised navigation map data and the position of the positioning coordinate.
